(19) United States
(12) Patent Application Publication
(10) Pub. No.: US 2009/0027170 A1
(43) Pub. Date: Jan. 29, 2009

(54) Two directional information flow in real time location sensing RFID networks

(76) Inventor: Israel Amir, Princeton, NJ (US)

Correspondence Address: Henry T. Brendzel, P.O. Box 574, Springfield, NJ, 07081, US

(21) Appl. No.: 11/881,631

(22) Filed: Jul. 27, 2007

(51) Int. Cl. H04B 7/00

(52) U.S. Cl. 340/10.31

(57) ABSTRACT

An RFID system with a plurality of tags and base stations where transmission of information to a specific tag is carried out by one of the base stations, where said one of the base stations is selected based on location of the tag relative to the plurality of the base stations; illustratively, by the base stations that is closest to the tag.

### BACKGROUND OF THE INVENTION

This invention relates to RFID tags and, more particularly, to communication of information to tags in the context of a network having a plurality of base stations.

Typical applications of RFID tags pertain to a need to determine the locations of items. An RFID tag is attached to the item, and the location of the item with the attached tag is determined by the use of base stations. Two basic RFID system approaches are used: synchronous, and asynchronous.

A synchronous system employs a system clock, and all base stations and tags are synchronized to the system clock. In some applications time is divided into frames, and each frame has two sub-frames. The first sub-frame is divided into K time slots, during each of which a different one of the base stations may broadcast information to the tags within its range; and the second sub-frame is divided into N time slots, during each of which a different one of the tags transmits information, and all base stations listen. N is the expected maximum number of tags that the system will handle, and K is the number of base stations. The timing is achieved by, illustratively, adding an additional time interval during which beacon signals are transmitted by the base stations and are used by the tags for synchronizing themselves to the system clock. That is, at the beginning of each frame there is a beacon time interval, and the base stations employ this time interval to each send out a synchronizing beacon. This is illustrated by the FIG. 1 timing diagram for an arrangement where N=8 and K=4.

An asynchronous system is one where the tags attempt to send information periodically, but there is no synchronization between the tags and other elements of the system.

Thus, regardless of whether a synchronous system is implemented, or an asynchronous system is implemented, the result is the same in the sense that each tag repetitively transmits information about itself, and the transmitted signal is received by one or more (it is hoped) or the base-stations. Based on the received signal power, or on time-of-flight information, the network of base stations determines, or rather estimates, the location of the tag (and, consequently, the item to which the tag is attached). It may be noted that in a copending application, titled “Dual Antenna Base Station for Improved RFID Localization,” and filed on even date herewith, the base stations use directional antenna arrangements that allow for easy determination of tag location by using simple comparison operations.

In a variant of the above approach a tag “listens” to synchronized beacon signals from the different base stations and, using the incoming power information of the received signals in conjunction with the known base station locations, the tag estimates its location (by use of a triangulation technique) and transmits this estimate.

One of the problems of prior art RFID networks is that they lack the ability for the base stations to transmit data that is destined only to a particular tag. The main difficulty stems from the fact that in prior art networks all of the base stations either listen to the tags, or broadcast to all tags; and when they broadcast, they do so other than concurrently, because transmitting concurrently may create “blind spots” that arise from overlapping and destructively combining transmissions.

### SUMMARY OF THE INVENTION

An advance in the art is achieved by introducing the ability to transmit information to a specific tag or tags, and by having only one base station transmit to a particular tag. The selection of a base station for this task of transmitting is based on the location of the tag, or effectively on the location of the tag, relative to the set of base stations. Illustratively, the base station that is chosen is the base station that is determined to be closest to the tag, or the base station that receives the strongest signal from the tag. The choice is made by a processor that communicates with the various base stations.

In a synchronous system a time interval that is devoted to a tag is illustratively divided into a transmitting mini-time slot and a receiving mini-time slot. During the transmitting mini-time slot the base station transmits the information it needs to transmit to the tag, and during the receiving mini-time slot the base station receives information from the tag. When the information that needs to be communicated to the tag is larger than what a mini-time slot can handle, the information is chunked into portions and the portions are transmitted in successive frames. In an asynchronous system, a tag transmits when it desires, and the base station determines whether the transmission is successful or is corrupted by, for example, a collision with another tag. Advantageously, in the course of transmitting whatever information the tag needs to transmit, the tag includes an acknowledgement to report on whether transmission to it was successful.

### BRIEF DESCRIPTION OF THE DRAWING

FIG. 1 presents a timing diagram of a synchronous real time location sensing RFID system;

FIG. 2 is a block diagram of such a system where tags can be located in any one of four different rooms of a building;

FIG. 3 presents another timing diagram from a synchronous real time location sensing RFID system that is well suited for transmitting information to a specified tag by using a single base station; and

FIG. 4 presents yet another timing diagram where a first sub-frame is devoted to transmissions to tags while a second sub-frame is devoted to transmissions by the tags.

### DETAILED DESCRIPTION

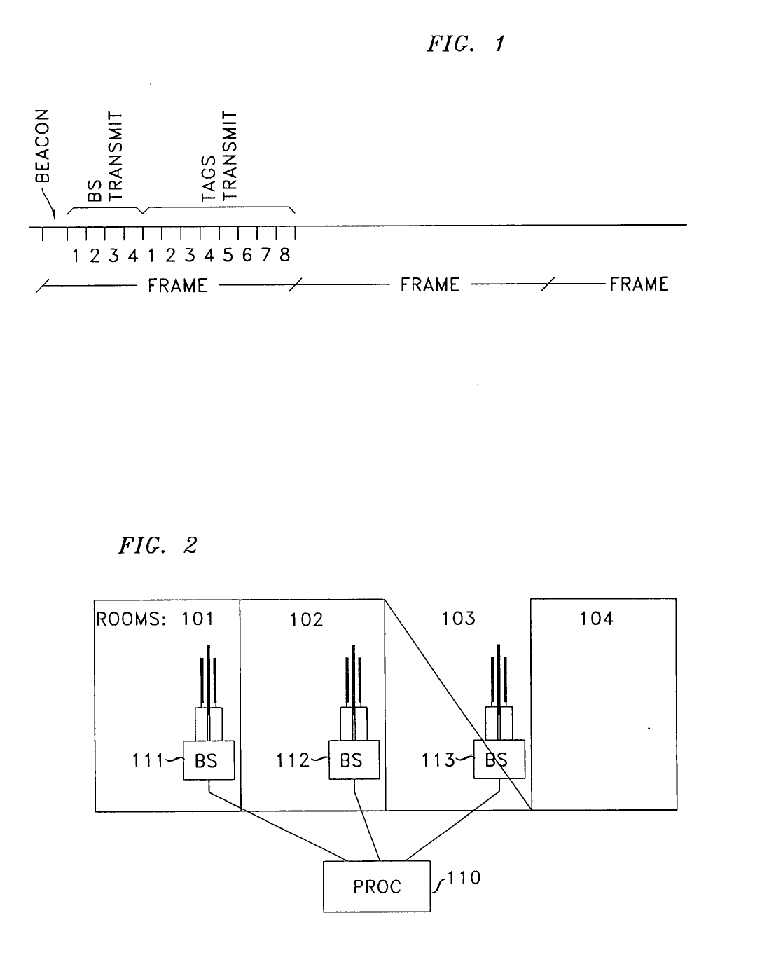

FIG. 2 depicts one illustrative embodiment of system to which the principles disclosed herein may be applied. It is a building with rooms 101, 102, 103, and 104, and a base station close to the right wall of rooms 101, 102, and 103; that is, base stations 111, 112, and 113. Each of the base stations has an antenna arrangement with two directional antennas that are directed at different directions and, thus, each base station outputs two signals that correspond to signals received from different directions. Under the assumption that a tag is in one of the rooms, the location of the tag is determined by an initial comparison within each base station of received power of the two signals so as to resolve the direction from which the tag is transmitting, followed by a determination (in processor 110) of a simple logical relationship between the directions resolved by the individual base stations.

One of the attributes of the FIG. 2 arrangement is that it is simple to determine the base station, and the particular directional antenna, that receives the signal of a given tag with the largest received power. To illustrate, when a tag is located in room 102 it is likely that the maximum power will be received either by the antenna of base station 111 that is directed to the right, or by the antenna of base station 112 that is directed to the left. Consequently it is quite simple to identify the room where the tag is located or, for example to identify the antenna that receives the most power.

Whether processor 110 identifies a particular base station based on the location of the tag, or based simply on received power, or based on some other criterion, the point to note is that processor 110 identifies a base station that is best suited for transmitting information to a tag, and assigns the task of transmitting to that identified base station. Illustratively, each of the base stations sends the received power information to processor 110, processor 110 determines the antenna with the highest received power, and assigns to that antenna the task of transmitting information to that particular tag in the next frame; that is, if there is information to be communicated.

In another illustrative embodiment, the base station that is assigned the task of transmitting information to a tag is the base station that is closest to the tag is some selected sense. For example, in the FIG. 2 arrangement where there are a number of rooms, and each room other than the last has one base station, the base station that transmits to a tag is the base station that is present in the room where the tag is estimated to be; for example, a tag that is in room 102 receives information from base station 112.

Viewed conversely, every base station has an assigned list of zero to K tags for which the base station is responsible (where K is the number of tags that the system is handling), but this assignment may change from time to time, based on the conditions in the building; such as a tag moving from one room to another.

Active RFID systems operate on the premise that low power consumption by the tags is of paramount importance and, therefore, a tags is powered down almost to zero, or made to “asleep,” at all times except when the tag wishes to transmit information; and in the context of this disclosure, a tags is asleep at all times except when it wishes to transmit information or it expects to receive information. Two types of systems are typically employed that conform to the above: synchronous systems and asynchronous systems. For both types of systems, however, only one base station is assigned the task of communicating with each tag that is detected by the system.

Synchronous System

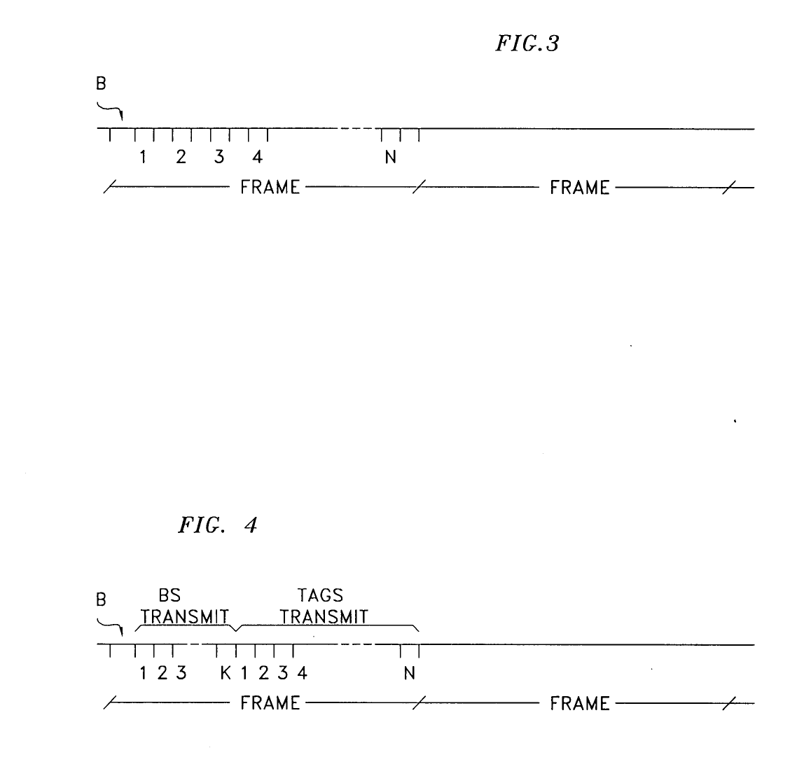

One timing schema that is advantageous for this arrangement is to have processor 110 periodically provide a synchronizing signal to all of the base stations, and to have each base station output a beacon that, inter alia, specifies the delay of that beacon signal relative to the synchronizing signal of processor 110. Thus, for example, the beacon signal of a first base station may “state” that it is being transmitted 1 ms after the synchronizing signal, the beacon signal of a second base station may “state” that it is being transmitted 8 ms after the synchronizing signal, etc. FIG. 3 depicts an illustrative timing diagram where all of the beacons follow each other in close proximity and following the beacon signals, the frame is divided into N time intervals with each time interval itself being divided into a receive portion followed by a transmit portion. During the receive portion of time slot j a tag that is assigned to time slot j receives information that is transmitted by the base station that is assigned the task of communicating with that tag, and during the transmit portion the tag transmits information about itself, including an acknowledgement about the receipt of information during the preceding interval. The information that is received contains, for example, an error detecting code, and the information that the tag transmits is an acknowledgement (based on assessment of the received information relative to the error detecting code) that the information arrived intact.

Given that a tag has a specified time slot in with a predetermined duration it is possible that the information that needs to be communicated to the tag exceeds the available duration of the time slot. In such a circumstance, that message is broken up into chucks, and the chunks are transmitted in successive frames. If a transmission of a chunk fails, the base station resends the chunk until it is received successfully; and clearly, if the tag is moved to a new location, the next transmission to the tag may occur from a different base station.

FIG. 4 presents yet another timing diagram, where a frame is divided into two sub-frames (not counting the beacons transmission interval), where the first sub-frame is devoted to transmissions to tags, while the second sub-frame is devoted to transmissions by the tags. Although both sub-frames are divided into time slots as in FIG. 1 timing diagram, the similarity is superficial. In FIG. 1, each time slot in the first sub-frame is devoted to a particular base station that broadcasts to all tags, whereas in FIG. 4 each time slot in the first sub-frame is devoted to transmission to a particular tag, as specified by information provided to tags during the beacon signal time slot. For example, the system might be designed to accommodate 256 tags, but the first sub-frame might have only 4 time slots. The beacon signal might specify that transmissions to tags 12, 22, 41, and 150 would take place and, accordingly, tag 12 would power up during the first time slot of the first sub-frame, tag 22 would power up during the second time slot of the first sub-frame, tag 41 would power up during the third time slot of the first sub-frame and, finally, tag 150 would power up during the fourth time slot of the first sub-frame. All other tags would remain in their sleep states during the first sub-frame.

### Asynchronous System

In an asynchronous system each RFID each tag transmits as it pleases or, more typically, each RFID has an internal clock and, based on that clock, the tag periodically wakes up, transmits information, and returns to sleep. Since these tags do no listening, it is not possible for base stations to inform a tag that information is sought to be communicated to it, although, as indicated above, one of the base stations is assigned the task of sending information to the tag (when such information needs to be communicated to the tag).

This problem is overcome by, for example, having each tag follow each transmission with a short period during which the tag remain powered up and ready to accept information that may be transmitted from a base-station. That additional short period may be fixed in duration, or sensitive to whether information is being received. For the latter embodiment, if information is not being received by the tag immediately following its transmission then the tag immediately returns to its sleep mode, before the duration of the short period expires. Otherwise, it continues to accept the incoming transmission.

If the duration of the listening period is fixed, then a base station is constrained to transmit only information that fits within the listening interval's fixed duration. If the information that needs to be communicated requires more time, then the information can be broken into chunks, as disclosed above in connection with synchronous systems. Alternatively, following a transmission a tag can stay powered up to determine whether a base station is transmitting to it and, if so, remain powered up until the transmission is completed. This approach is, of course, simpler, but it may increase the burden when a collision occurs.

Indeed, the main disadvantage of asynchronous systems is collisions that can occur in the course of tags transmitting information and in the course of tags receiving information. Those collisions are caused by other tags that transmit information without regard to whether the transmission medium is unoccupied. If such a collision occurs in the course of the tag transmitting information, it is possible to ignore the collision because the tag will transmit the same information to the base stations in the next frame and, therefore, the information will eventually be received. All that is needed is for the information transmitted by the tag having an embedded code (e.g. a CRC code) that allows a receiving base station to know whether it received a bona fide message or a corrupted message. However, if such a collision occurs in the course of the tag transmitting information, the situation is somewhat different. There is no inherent need for a base station to retransmit information that had been properly received and, therefore, it is generally desirable to know if and when a collision does occur. In accord with the principles disclosed herein, the information transmitted by the tag includes an acknowledgement as to whether the transmission to the tag was successful. If course, the information sent by the base station needs to include a code that allows a tag to determine whether it successfully received a transmission. If the transmission was not successful, the base station repeats the transmission the next time the tag wakes up, transmits information, and enters a listening, period. It is noted that the tags not only operate asynchronously from each other but, advantageously, they operate with sleep intervals that are not of constant value; e.g., pseudorandom in duration.

1. A system including a plurality of base stations and a plurality of tags, where most of the time said tags are in a powered-down mode, which consumes significantly less power than said tags are in a powered-up mode, and said tags are repetitively powered up to transmit a signal that is received by one of more of said base stations, characterized by:
a selected one of said base stations transmitting information to a specific tag of said tags, during a time when said specific tag is powered up.

2. The system of claim 1 where each tag of said plurality of tags has a single base station that is assigned a task of transmitting information to said each tag, thus each base station has a collection of M tags for it maintains responsibility to send information where n is any number between 0 and N, where N is the number of tags in said plurality of tags.

3. The system of claim 2 where the assignment of tags to base stations is made by a processor that communicates with said base stations.

4. The system of claim 3 where the assignment is reevaluated every altered from time to time.

5. The system of claim 1 where said base station that transmits information to said specific tag is selected based on position of said tag relative to said plurality of base stations.

6. The system of claim 5 where said position is determined based on signal strength information, or on location estimation, of said tag relative to said plurality of base stations.

7. The system of claim 1 where the base station that is selected is the base station of said base stations that is closest to said tag, or one that receives the strongest signal, relative to others of said base stations.

8. The system of claim 1 where the tags operate asynchronously of each other.

9. The system of claim 8 where a tag, following a period of transmission, remains in powered-up mode for a preselected period of time to determine whether that tag receives a transmission from a base station, and
when the tag determines that it receives said transmission, the tag
remains in its powered up mode;
receives said transmission; and
enters a powered-down mode when it determines that the transmission terminated; and
when the tag determines that it is not receiving said transmission, enters said powered-down mode.

10. The system of claim 9 where during said period of transmission the tag sends an acknowledgment regarding a transmission previously received by the tag.

11. The system of claim 8 where a tag, following a period of transmission, remains in powered-up mode for a preselected period of time to determine whether it receives a transmission from a base station, and
when the tag determines that it receives said transmission, the tag
remains in its powered up mode;
receives said transmission;
sends an acknowledgement when it determines that the transmission terminated; and
enters a powered-down mode following the sending of said acknowledgment; and
when the tag determines that it is not receiving said transmission, entered said powered-down mode.

12. The system of claim 1 where that base stations and the tags are synchronized to a given clock.

13. The system of claim 12 where synchronization information about said given clock is provided by said base stations to said tags through beacon signals that are transmitted by the base stations.

14. The system of claim 13 where said beacon signal broadcasts information.

15. The system of claim 14 where said information includes information that identifies tags to which subsequent time slots destine information.

16. The system of claim 1 further comprising a processing module to which said base stations send information.

17. The system of claim 16 where that base stations and the tags operate off a common clock.

18. The system of claim 17 where said common clock resides in said processing module.

19. The system of claim 17 where time measured by said common clock is divided into frames and each frame contains a beacon time slot, a first plurality of time slots for base stations to transmit information to tags, and a second plurality of time slots for tags to transmit information to base stations.

20. The system of claim 19 where said selected one of said base stations transmits to a tag at a time slot of said first plurality of time slots that is assigned to said tag.

21. The system of claim 19 where said selected one of said base stations transmits to a tag at a time slot of said first plurality of time slots that is assigned to said tag, and said tag transmits information during a time slot of said second plurality of time slots, which information includes an acknowledgment when said transmission from said one of said base stations is received intact.

22. The system of claim 19 where said first plurality is less than said second plurality.

23. The system of claim 19 where said first plurality is equal to said second plurality.
